(19) United States
(12) Patent Application Publication
(10) Pub. No.: US 2006/0280207 A1
(43) Pub. Date: Dec. 14, 2006

(54) Distributed network monitoring system

(76) Inventors: Stephen Guarini, San Jose, CA (US); Tomas J. Pavel, San Jose, CA (US); Mark Crane, Sparks, NV (US); Erik Seilnacht, San Francisco, CA (US); Romain Kang, Sunnyvale, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/148,055

(22) Filed: Jun. 8, 2005

(51) Int. Cl. H04J 3/12

(52) U.S. Cl. 370/524; 370/250; 709/223

(57) ABSTRACT

A distributed network monitoring system includes a central monitoring device configured to store global configuration information for all monitoring devices which make up the distributed system, and one or more remote monitoring devices configured to receive, in response to a request therefor, at least a portion of the configuration information from the central monitoring device. The remote monitoring devices and the central monitoring device may be communicatively coupled through respective secure communications paths (e.g., SSH communication tunnels) established on an as-needed basis by secure communication tunnel processes executing at the central monitoring device and remote monitoring devices. The central network monitoring device may further include a configuration servlet configured to provide requested portions of the configuration information to the one or more remote monitoring devices.

### FIELD OF THE INVENTION

The present invention relates to the architecture and operation of a distributed network monitoring system configured for monitoring operations of one or more computer networks.

### BACKGROUND

Today, information technology professionals often encounter a myriad of different problems and challenges during the operation of a computer network or network of networks. For example, these individuals must often cope with network device failures and/or software application errors brought about by such things as configuration errors or other causes. In order to permit network operators and managers to track down the sources of such problems, network monitoring devices capable of recording and logging vast amounts of information concerning network communications have been developed.

Conventional network monitoring devices, however, suffer from scalability problems. For example, because of finite storage space associated with such devices, conventional network monitoring devices may not be able to monitor all of the nodes or communication links associated with large enterprise networks or networks of networks. For this reason, and as described in co-pending U.S. patent application Ser. No. 11/092,226 assigned to the assignee of the present invention and incorporated herein by reference, such network monitoring devices may need to be deployed in a network of their own, with lower level monitoring devices reporting up to higher level monitoring devices.

In such a network of monitoring devices it is important to allow for centralized control of the monitoring devices. Additionally, some means of inter-device communication is generally needed. The present invention addresses these needs.

### SUMMARY OF THE INVENTION

A distributed network monitoring system includes a central monitoring device configured to store global configuration information for all monitoring devices which make up the distributed monitoring system, and one or more remote monitoring devices communicatively coupled to the central monitoring device and configured to receive, in response to a request therefor, at least a portion of the configuration information from the central monitoring device. The remote monitoring devices and the central monitoring device may be communicatively coupled through respective secure communications paths (e.g., SSH communication tunnels) established on an as-needed basis by secure communication tunnel processes executing at the central monitoring device and remote monitoring devices. The central network monitoring device may further include a configuration servlet configured to provide the portion of the configuration information, e.g., as XML documents, to the one or more remote monitoring devices in response to the requests therefor, e.g., in response to requests from configuration daemons executing at the one or more remote monitoring devices. The configuration daemons may request configuration information on command from the central monitoring device, or may request such information when needed (e.g., at startup). The central network monitoring devices may be arranged in a multi-tiered system if so desired.

### BRIEF DESCRIPTION OF THE DRAWINGS

The present invention is illustrated by way of example, and not limitation, in the figures of the accompanying drawings in which:

FIG. 1 illustrates an example of a network monitoring device deployed so as to monitor traffic to and from various network nodes arranged in logical groupings;

FIG. 2 illustrates an example of a network of network monitoring devices;

FIG. 3 illustrates Director and Appliance network monitoring devices and a Management Console therefor configured in accordance with an embodiment of the present invention;

FIG. 4 illustrates an example of a distributed network monitoring system having secure communication paths configured between a director and a number of Appliances in accordance with embodiments of the present invention;

FIG. 5 is a flow diagram illustrating a process for adding an Appliance to a distributed network monitoring system in accordance with an embodiment of the present invention; and

FIG. 6 is a flow diagram illustrating a process for updating configuration information on an Appliance in accordance with an embodiment of the present invention.

### DETAILED DESCRIPTION

Described herein is a distributed network monitoring system adapted for monitoring one or more computer networks or networks of networks. Although discussed with respect to various illustrated embodiments, however, the present invention is not meant to be limited thereby. Instead, these illustrations are provided to highlight various features of the present invention. The invention itself should be measured only in terms of the claims following this description.

Various embodiments of the present invention may be implemented with the aid of computer-implemented processes or methods (a.k.a. programs or routines) that may be rendered in any computer language including, without limitation, C#, C/C++, Fortran, COBOL, PASCAL, assembly language, markup languages (e.g., HTML, SGML, XML, VOXML), and the like, as well as object-oriented environments such as the Common Object Request Broker Architecture (CORBA), Java™ and the like. In general, however, all of the aforementioned terms as used herein are meant to encompass any series of logical steps performed in a sequence to accomplish a given purpose.

In view of the above, it should be appreciated that some portions of the detailed description that follows are presented in terms of algorithms and symbolic representations of operations on data within a computer memory. These algorithmic descriptions and representations are the means used by those skilled in the computer science arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. It should be borne in mind, however, that all of these and similar terms are to be associated with the appropriate physical quantities and are merely convenient labels applied to these quantities. Unless specifically stated otherwise, it will be appreciated that throughout the description of the present invention, use of terms such as “processing”, “computing”, “calculating”, “determining”, “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention can be implemented with an apparatus to perform the operations described herein. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and processes presented herein are not inherently related to any particular computer or other apparatus. Various general-purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor or by any combination of hardware and software. One of ordinary skill in the art will immediately appreciate that the invention can be practiced with computer system configurations other than those described below, including hand-held devices, multiprocessor systems, microprocessor-based or programmable consumer electronics, DSP devices, network PCs, minicomputers, mainframe computers, and the like. The invention can also be practiced in distributed computing environments where tasks are performed by remote processing devices that are linked through a communications network. The required structure for a variety of these systems will appear from the description below.

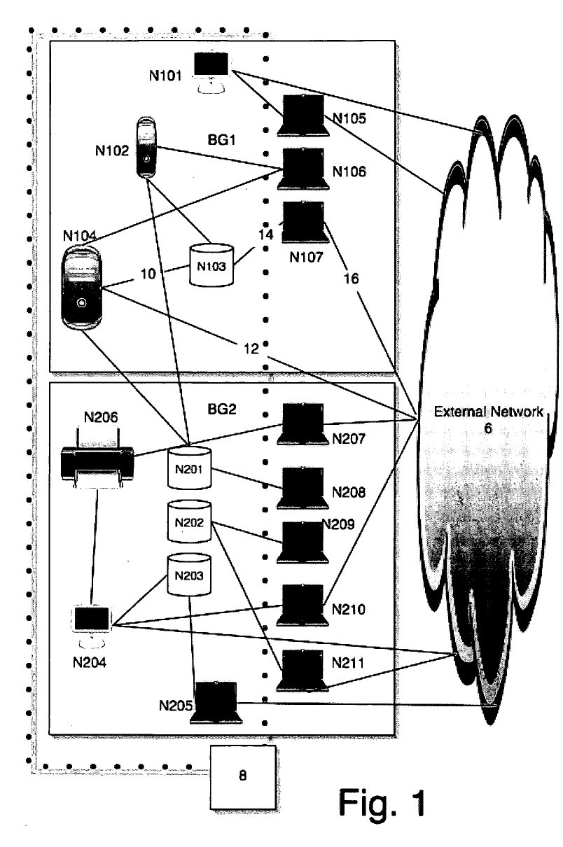

Turning now to FIG. 1, a computer network including multiple logical groupings (e.g., BG1, BG2) of network nodes is illustrated. Logical groupings such as BG1 and BG2 may be defined at any level. For example, they may mirror business groups, or may designate computers performing similar functions, computers located within the same building, or any other aspect that a user or network operator/manager wishes to highlight. In the example shown in FIG. 1, BG1 contains several internal network nodes N101, N102, N103, and N104 and external nodes N105, N106 and N107. Similarly, BG2 contains several internal network nodes N201, N202, N203, N204, N205, N206.

For purposes of the present example, a network node may be any computer or other device on the network that communicates with other computers or devices (whether on the same network or part of an external network 6). In FIG. 1 lines between nodes and other entities are meant to indicate communication links, which may be any mode of establishing a connection between nodes including wired and/or wireless connections. Each node may function as a client, server, or both. Furthermore, network nodes need not be within the internal network in order to belong to a logical group. For example, network nodes N105, N106, N107 belong to logical group BG1, but are outside a local firewall (shown as a dashed line), and may be geographically distant from the other network nodes in BG1. Similarly, network nodes N207, N208, N209, N210, N211 are members of logical group BG2, but are physically removed from the other members of BG2. It is important to note that the firewall is shown for illustrative purposes only and is not a required element in networks where the present invention may be practiced. The separation between internal and external nodes of a network may also be formed by geographic distance, or by networking paths (that may be disparate or require many hops for the nodes to connect to one another regardless of the geographic proximity).

FIG. 1 thus illustrates one simple organization of a small number of computers and other network nodes, but those familiar with computer network operations/management will appreciate that the number of computers and network nodes may be significantly larger as can the number of connections (communication links) between them. A network traffic monitoring device 8 is shown at the firewall. However, the network traffic monitoring device 8 may be located anywhere within the internal network, or even the external network 6 or, in fact, anywhere that allows for the collection of network traffic information. Note further that network traffic monitoring device 8 need not be “in-line.” That is, traffic need not necessarily pass through network traffic monitoring device 8 in order to pass from one network node to another. The network traffic monitoring device 8 can be a passive monitoring device, e.g., spanning a switch or router (span or tap), whereby all the traffic is copied to a switch span port which passes traffic to network traffic monitoring device 8. The network traffic monitoring device can also use passive optical taps to receive a copy of all traffic.

For a relatively small network such as that shown in FIG. 1, a single network monitoring device 8 may suffice to collect and store network traffic data for all nodes and communication links of interest. However, for a network of any appreciable size (or for a network of networks), this will likely not be the case. Thus, the present invention permits multiple such network monitoring devices to be deployed so that a network operator/manager can be certain that data for all nodes/links of interest is collected. To permit ease of management and centralized control, the present invention further allows the network operator to deploy such network monitoring devices in a network of their own, thus forming a distributed network monitoring system.

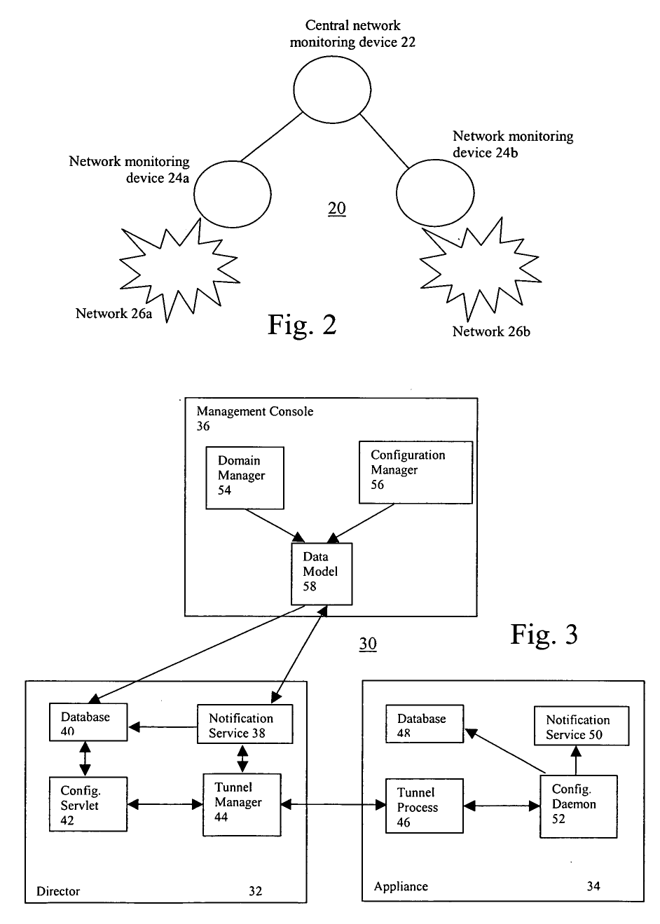

A simple example of such a network 20 of network monitoring devices is illustrated in FIG. 2. In this example, a central network monitoring device 22 (hereinafter termed the Director) receives information from two individual network monitoring devices 24ₐ a and 24_{b} (each hereinafter referred to as an Appliance). Appliance 24ₐ is responsible for collecting data associated with a local network 26ₐ. Appliance 24_{b} is responsible for collecting data associated with a local network 26_{b}. Networks 26ₐ and 26_{b} may each include multiple nodes, interconnected with one another and/or with nodes in the other respective network by a myriad of communication links, which may include direct communication links or indirect communication links (e.g., which traverse other networks not shown in this illustration). Thus, the total number of monitored nodes/links may be quite large, such that no single monitoring device could store and/or process all of the network traffic information being collected.

Each of the Appliances 24ₐ and 24_{b} may be responsible for collecting data concerning multiple groupings of nodes in their associated networks 26ₐ and 26_{b}. That is, the network operator may, for convenience, define multiple logical and/or physical groupings of nodes in each of the networks 26ₐ and 26_{b} and configure the respective Appliances 24ₐ and 24_{b} to store and track network traffic information accordingly. Alternatively, or in addition, local network operators may separately configure each of the local Appliances 24ₐ and 24_{b} in accordance with their needs. As will be discussed further below, the present invention allows for separate global and local configurations of each such Appliance and includes methodologies for resolving conflicts between such configurations. Among other things, these configurations may include the definitions of various logical groupings of network nodes and/or user accounts.

Referring now to FIG. 3, an example of a distributed network monitoring system 30 is shown in further detail. In this example, the system 30 includes a Director 32 and an Appliance 34. Of course there may be many other Appliances (and even other Directors), but each is substantially similar to that illustrated in FIG. 3 and so the example of just one Appliance (and Director) is sufficient to communicate the aspects of the present invention.

One advantage afforded by the present invention is the ability of a network operator to control all aspects of network monitoring system 30 using a single user interface: management console 36. Management console 36 may be instantiated as a graphical user interface and associated components of a personal computer or other computer-based platform. The management console 36 provides communication between the user and the Director 32 and, in turn, between the user and all of the Appliances 34 as will be described further below. The use of a single management console 36 affords two advantages: First, the user can seamlessly review network monitoring data collected by any of the monitoring devices in system 30, whether that data is hosted at Director 32 or one of the Appliances 34. That is, the single management console allows for viewing of collected data across any monitoring device. Data collected by the Appliances 34 may be aggregated and reported (e.g., in summary form) to the Director 32 for local storage and methods for doing so are described further in the above-cited U.S. patent application incorporated herein by reference. Second, the single management console 36 allows for central configuration of any necessary user-definitions to any and all monitoring devices. That is, any configuration changes or updates required at any monitoring device can be implemented through the single management console.

Director 32 includes four modules of interest in connection with the present invention. As indicated above, these modules may be implemented in computer software for execution by a computer processor in accordance with the instructions embodied therein. The processor itself may be part of a conventional computer system, including read and write memory, input/output ports and similar features. The modules are: a notification service 38, a database 40, a configuration servlet 42 and a tunnel manager 44.

The notification service 38 is configured to communicate with the management console 36, for example to receive user-initiated indications that configuration updates are ready to be sent to the Appliances 34. In addition, the notification service 38 provides alerts and other notifications to users (via the management console 36) when the Director 32 receives reports from the Appliances 34. In general then, the notification service acts as an announcement indicator for both incoming and outgoing messages to/from Director 32.

Notification service 38 passes messages to/from the Appliances 34 through secure, SSH tunnels. Tunnel manager 44, which is communicatively coupled to the notification service 38, is responsible (together with a similar tunnel process 46 located at Appliance 34) for establishing those tunnels. SSH tunnels are well known in the computer networking arts but are generally used for individualized communications, such as retrieving e-mail from a host server. In the present invention, such tunnels are used for multiple services, with each service being akin to a channel within the Director-to-Appliance tunnel. SSH itself is a well-known communication protocol defined, for example, in the OpenBSD Reference Manual published by Berkeley Software Design, Inc. and Wolfram Schneider (September 1999). The SSH protocol allows local computer applications to log into remote computer devices and execute command thereon. It provides a secure communication path between the local and remote systems (indeed between any two untrusted hosts) over insecure networks through the use of asymmetric keys for the encryption/decryption of messages. Tunnel manager 44 and tunnel process 46 may therefore be instantiated as conventional SSH tunnel managers/processes (configured to provide the services described herein), with tunnel manager 44 being the parent process and tunnel process 46 being the child process.

Appliance 34 communicates with configuration servlet 42 via the SSH tunnels established via the tunnel managers/processes. Configuration servlet 42 may be instantiated as a JAVA-based process for extracting configuration data from database 40 and providing that data, in a format such as the extensible markup language (XML) or another file format, to Appliances 34 in response to requests originating from Appliance 34. The configuration servlet 42 may therefore be any convenient interface for passing such database requests and responses to/from database 40.

The configuration servlet 42 is also responsible for “versioning” the configuration data in a manner appropriate to the Appliance that is connecting to it via an SSH tunnel. That is, the configuration servlets 42 are configured to recognize differences between configuration information/formats across different Appliances and to provide updates accordingly. In a large distributed system there may be multiple Appliances at different software version levels across the network. For example, an Appliance may have been earlier removed from the distributed system and then later returned. During the absence from the system, the configuration information stored by the Appliance may have become stale. Accordingly, when the Appliance is returned to the distributed system it requests a full configuration update from the Director. In order to respond to this request, the Director needs to know which format/version of the configuration information to send.

With the “push-pull” architecture of the present configuration servlets 42, the Director is able to interpret the current version of the Appliance through a message passed from the tunnel process on the Appliance to the Director. The Director can then construct/format the configuration information in the manner appropriate to the version that the Appliance will recognize and push that information back out to the Appliance. This allows the system to handle Appliances with differing versions.

Database 40 may be any convenient form of database for storing configuration information provided via management console 36 and intended for use by Director 32 and Appliances 34. The configuration information may include such things as logical groupings of network nodes to be monitored, user accounts, etc. The precise form of database is not critical to the present invention, but may be a relational database or other form of conventional database. The notification service 38 may pass messages to management console 36 so as to alert all processes in the system and all users that new configuration information has been stored in database 40.

In some embodiments, in addition to storing configuration information the database 40 will also store network monitoring data and statistics reported by the Appliances 34. Such data may also be reported via the SSH tunnels and passed to database 40. The network monitoring data may be stored separately (e.g., physically or logically) from the configuration data.

As indicted above, each Appliance 34 includes a tunnel process 46, which together with tunnel manager 44 at Director 32 is responsible for setting up secure communication pathways between the Appliance 34 and Director 32. In addition, each Appliance 34 includes a database 48, a notification service 50 and a configuration daemon 52. Database 48 may be any form of conventional database and is used to store configuration information provided via Director 32, network monitoring data collected from communication links and nodes for which the Appliance 34 has monitoring responsibilities and, in some cases, local configuration information entered by a local network operator. The configuration information is stored in the database under the control of the configuration daemon 52, as will be discussed further below.

Notification service 50 is similar to notification service 38 and is configured to provide local network operators with indications of changes to the Appliance configuration and other information via local user interface (not shown). Notification service 50 then is a computer process used in a manner akin to a doorbell in as much as it provides for an announcement of some other information.

Configuration daemon 52 is responsible for requesting updated configuration information from configuration servlet 42 on Director 32 in response to a notification from notification service 38 that such information is available. The daemon 52 also acts as an interface for passing that configuration information to the Appliance database 48. As the name implies, configuration daemon 52 is a software program configured to perform housekeeping or maintenance functions without being called by a user. It is activated when needed, for example, to store configuration updates from Director 32.

Management console 36 may include a multitude of “manager” processes, including: a domain manager 54 and a set of user-definition configuration managers 56. The domain manager 54 is configured to manage configurations of the various Appliances 34 that are “clustered” to the Director 32. This includes adding, removing and disconnecting Appliances 34 from the distributed system. In addition, properties of the Appliance, such as its name, IP address, etc., can be configured via domain manger 54. Thus, domain manager 54 is responsible for keeping track of the overall architecture of the distributed system 30 and controls the addition, updating and removal of devices therefrom. It may be regarded as a software program through which a user can specify such additions, updates and removals and therefore is best considered as a portion of the user interface that makes up the management console 36.

The user-defined configuration manager 56 is the portion of the user interface through which a network operator may specify and change individual Appliance (or Director) configurations. For example, the configuration manager 56 may be used to define various logical groupings of nodes or alert conditions for monitoring by one or more Appliances, the type of data to be reported back to the Director 32, etc. In some embodiments, the functionality of domain manager 54 and configuration manager 56 may be provided in a single module or more than two modules.

Each of the manager modules must communicate with the Director 32 and in particular the database 40. For example, configuration data entered by the user is stored in database 40 before being passed on to the appliances 34. Thus, the managers utilize a common data model 58 for passing information to and receiving information from the Director 32. This includes any notification messages passed to/from the notification service 38. The data model may be any convenient data model and the precise syntax of the data model is not critical to the present invention.

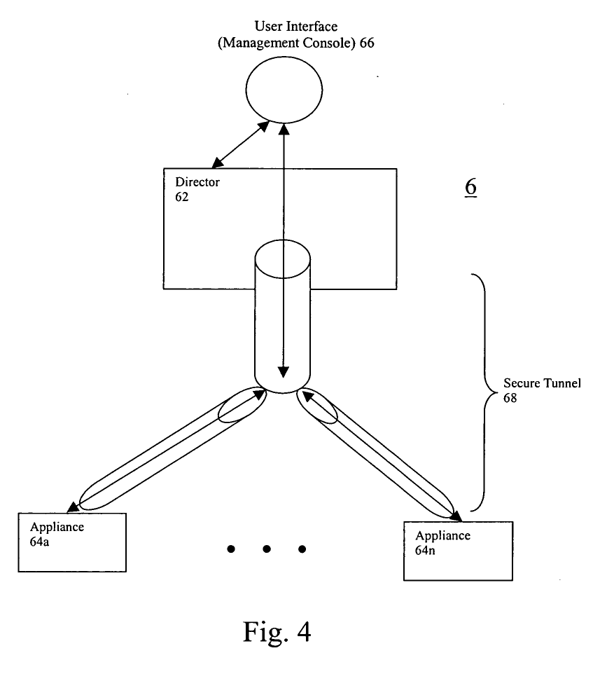

With the above in mind, FIG. 4 now provides a view of an example of a distributed network monitoring system 60 configured in accordance with an embodiment of the present invention. The monitoring system 60 includes a Director 62 and multiple Appliances 64a-64n. A user interface (management console) 66 is provided for a central network operator to control the distributed system 60 and to review any network data collected in accordance with configuration instructions. As shown, the user interface 66 is associated with and communicatively coupled to the Director 62, but may be used to directly access data stored by any of the Appliances through the secure tunnel mechanism 68.

The distributed network monitoring system 60 implements a “push-pull” protocol when information is to be exchanged between any of the Appliances 64 and the Director 62. For example, when an Appliance (say Appliance 64a) has network monitoring data ready for collection by the Director 62, the Appliance will notify the Director of the availability of the information (e.g., via its associated notification service). In response, and at a time convenient for the Director, the Director 62 will pull the new data from the Appliance (e.g., via the secure communication tunnel therebetween). The monitoring data is pulled directly from the database using the established SSH tunnel.

In a similar fashion, when the Director 62 has new configuration information it may issue a notification to the Appliances 64. The Appliance then pulls the new configuration data from the Director 62. Such activities may be carried out using conventional hypertext transfer protocol (http) exchanges. For example, the Appliance 64 may use an http GET request to request a portion of the available configuration data. These communication types are well documented in RFC 2616 by Fielding et al. and need not be discussed further herein. In one embodiment of the present invention, the GET request seeks only the most recent updates to the configuration information and not an entire configuration file, unless there is a need for such an entire file (e.g., a long time may have passed between updates and so a timer may have expired for such action, the Appliance may be new to the distributed system or have recently suffered a communication failure or other event that caused it to be absent from the system, and so on). This ability to push only partial configurations (e.g., only changes in previously established configurations) is beneficial because transmitting an entire configuration file can result in long processing times by each of the monitoring devices receiving such a file. The configuration information itself may be embodied in an XML format, making it relatively easy to communicate by means of these http message structures. As explained above, the XML documents are versioned by the Director 62 so as to accommodate an overall system made up of a number of Appliances of differing versions. Of course, any other message format and/or communication protocol may be used. When the Appliance 64 has completed its update according to the new configuration information it may so notify the Director 62 and/or may report any failures experienced while trying to complete the update. Failures are logged on the Director 62 and may be viewed by the user via the management console 66. The system is robust to the failure of any one individual Appliance's configuration operation. If configuration results are not received from an appliance within a specified time period, the Director may move on to a next configuration operation and the affected Appliance may asynchronously report its results at a later time.

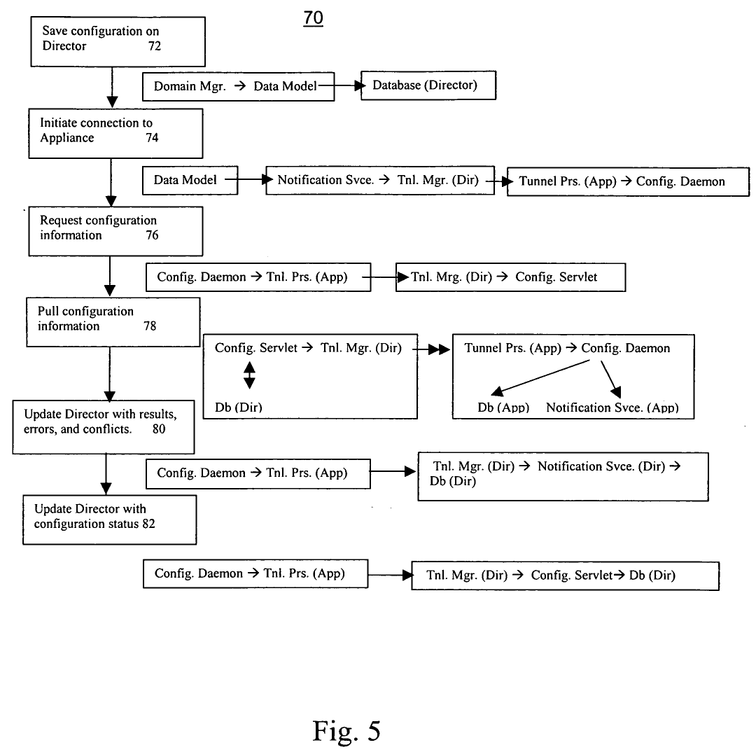

FIG. 5 illustrates an example of how a new Appliance may be added to the distributed network management system. Assuming the hardware components have been installed, the process 70 beings with the network operator (or other user) saving the configuration information for the new Appliance to the Director (step 72). This involves specifying the new configuration information using the domain manager of the management console and, via the data model, saving that configuration to the database on the Director. Next, at step 74, a connection to the new Appliance is initiated. Generally, this may be done in response to a user command (again issued via the domain manager) to install the configuration on the Appliance. In response, the notification service module on the Director will instruct the tunnel manager to set up a secure communication path with its counterpart at the new Appliance. When the tunnel has been established, the tunnel manager starts the configuration daemon, which then pulls the full configuration from the Appliance.

In response, the configuration daemon requests the new configuration information (step 76). This request (which may be an http GET request) is passed via the secure tunnel to the configuration servlet at the Director. In response, the configuration servlet pulls the requested information from the database at the Director and responds to the request by passing the configuration information back through the secure tunnel (e.g., as a reply to the http GET message) (step 78). As this information is received, the configuration daemon at the Appliance may store the information to the Appliance database (or, alternatively, the daemon may wait until all of the information has been received before storing it to the database). Generally, this will have the effect of changing the configuration of the Appliance (e.g., in terms of establishing the nodes for which data is to be collected, etc.).

Thereafter, the configuration daemon may notify the local notification service that it has completed the update of the configuration information, for example, so that appropriate update messages may be passed to local users of the Appliance. If any local configuration information was previously stored on the Appliance, during the installation of the global configuration information it may have been necessary to resolve certain conflicts. For example, different groups of nodes may have been designated by similar names or labels. In order not to disturb global configuration information applicable across the entire distributed monitoring system, the configuration daemon will resolve such conflicts in favor of the global information and rename or otherwise update the local configuration information. Thus, the notifications to local users may include such renaming or other information made necessary by the new global configuration information.

One area where this policy of favoring global configuration information may not apply, however, is in the area of user accounts, for it would not be advisable to change local user account information (e.g., log-in names and passwords) without explicit instructions from the affected users. Hence, in one embodiment of the present invention conflicts among such user account information is not automatically resolved by the configuration daemon and instead the user is advised of the conflict via the Director notification service. Moreover, the present invention provides the ability to enforce conflict rules that may vary based on the configuration type; for example, conflict rules for determining which of two (or more) competing configuration parameters (e.g., business group names) to keep when a global definition (one affecting system-wide configuration information) usurps or assimilates a local definition (e.g., one applicable only at a single Appliance). For each user-definition type a custom set of rules is determined and applied for resolving such conflicts.

With the update of the Appliance complete (except perhaps for any irresolvable conflicts requiring user attention), the configuration daemon notifies the Director that it has completed its update (step 80). This may be done by passing an appropriate message through the secure tunnel to the notification services, which saves the results, including conflict and error information, in the database at the Director. Any errors or conflicts are stored on the Director and reported back to the user, so the user can resolve these errors or conflicts. In addition, the notification service at the Director may be prompted to issue an appropriate message to the network operator via the management console, advising the operator of successful installation of the new Appliance. In the event any errors or unresolved conflicts were present during the installation, the configuration daemon may so notify the Director (and the user). The actual configuration status of the Appliance is reported to the Director (step 82), for example by an exchange of configuration information between the configuration daemon of the Appliance and the configuration servlet of the Director (through the secure tunnel) which then saves the status in the database on the Director.

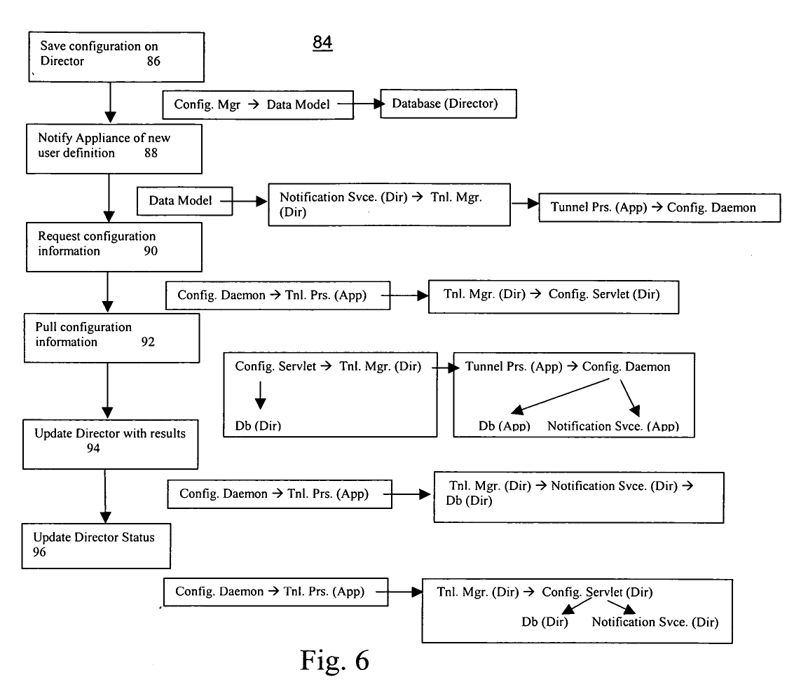

Turning now to FIG. 6, an example of a process 84 for updating the configuration of an existing Appliance is illustrated. As before, the new configuration information is saved to the Director (step 86) and the Appliance notified of its availability (step 88) by the Director's notification service. This time, however, the user may save such information to the Director using the configuration manager portion of the user interface (inasmuch as the other information needed to install an Appliance is not necessary). Upon being notified of the availability of new configuration information, the configuration daemon of the Appliance sends a request (e.g., an http GET for example) for the information (step 90) via the secure tunnel to the Director. This tunnel, once established, is maintained and is used to pass both the configuration and network monitoring data from the Appliance.

In response, the configuration servlet at the Director pulls the requested information from the database at the Director and passes it back to the Appliance (step 92). As before, as this information is received the configuration daemon at the Appliance stores the information to the Appliance database thereby updating the configuration of the Appliance. When the process is complete, the configuration daemon updates the Director and the local Appliance notification service with the results (step 94). Such an update may include information about any configuration that could not be installed, any other errors that were encountered, and/or any conflict resolution that was needed with local configuration information.

Thus, a distributed network management system has been described. Among the advantages afforded by the present invention is the ability for a network operator to specify configuration parameters for group of network monitoring devices once, and have that configuration information automatically distributed to all network monitoring devices in the system. This can be a convenient time saver and also helps to ensure that all of the devices are provided with common configuration information (i.e., minimizing errors). At the same time, local configuration information for the network monitoring devices is preserved, allowing local network operators to manage items of local interest. Automatic conflict resolution (provided by the configuration daemon at the Appliances) helps to ensure that global configuration states are given preference so as to retain common configurations across the entire system and also allows for a common global/local configuration name space to be adopted.

The present distributed system also provides for a single point of monitoring. That is, using the present invention, a network operator can seamlessly access (via secure communication paths) network monitoring information stored on any device within the system without having to connect to that device locally. By providing tunneled communications through the Director, the present invention allows the network operator to directly access information stored in any of the Appliance databases.

Additionally, the distribution of configuration information may be performed using a push-pull or asynchronous communication protocol as discussed above. This same communication plan can be used for passing summary network monitoring information from the Appliances to the Director, thereby allowing the network operator to access such summary information at the Director (and thus conserving bandwidth within the distributed system). Likewise, software updates other than configuration information can be passed by similar mechanisms. The push-pull nature of these communications is beneficial in that if an Appliance is temporarily unavailable (e.g., due to communication failures or other reasons), the Appliance can easily request any missed updates (or an entire refresh of its configuration state) upon rejoining the system. Moreover, Appliances are free to request only that configuration information (or updates thereto) which are applicable for their individual roles. There is no need to provide system-wide configuration information if it is not needed by one or more appliances. By establishing timeouts for configuration operations, the Director is immune to problems caused by a slow, or no, response from any individual Appliance. The Appliance can catch up at a future time by requesting its configuration data and reporting its results to the Director asynchronously.

The illustrations referred to in the above description were meant not to limit the present invention but rather to serve as examples of embodiments thereof and so the present invention should only be measured in terms of the claims, which follow.

What is claimed is:

1. A distributed network monitoring system, comprising a central monitoring device configured to store global configuration information for all monitoring devices which make up the distributed monitoring system, and one or more remote monitoring devices communicatively coupled to the central monitoring device and configured to receive, in response to a request therefor, at least a portion of the configuration information from the central monitoring device.

2. The distributed network monitoring system of claim 1, wherein the remote monitoring devices and the central monitoring device are communicatively coupled through respective secure communications paths established on an as-needed basis by secure communication tunnel processes executing at the central monitoring device and remote monitoring devices.

3. The distributed network monitoring system of claim 2, wherein the secure communication paths comprise SSH communication tunnels.

4. The distributed network monitoring system of claim 1, wherein the central network monitoring device includes a configuration servlet configured to provide the portion of the configuration information to the one or more remote monitoring devices in response to the requests therefor.

5. The distributed network monitoring system of claim 4, wherein the configuration servlet is configured to respond to requests from configuration daemons executing at the one or more remote monitoring devices.

6. The distributed network monitoring system of claim 5, wherein the configuration daemons are configured to initiate the requests for the configuration information in response to notification messages received from the central network monitoring device.

7. The distributed network monitoring system of claim 5, wherein the configuration servlet is configured to interpret, from the requests received from the configuration daemons, version information for the remote monitoring devices.

8. The distributed network monitoring system of claim 7, wherein the configuration servlet is further configured to respond to the requests from the configuration daemons with configuration data appropriately formatted for respective versions of the remote monitoring devices requesting the configuration data.

9. The distributed network monitoring system of claim 1, further comprising a management console communicatively coupled to the central monitoring device and configured to permit a user to review data collected by any of the one or more remote monitoring devices of the distributed network monitoring system through communications across secure communications paths established on an as-needed basis between the central monitoring device and the remote monitoring devices.

10. The distributed network monitoring system of claim 9, wherein the management console is further configured to permit the user to manage configurations of the one or more remote monitoring devices communicatively coupled to the central monitoring device.

11. The distributed network monitoring system of claim 10, wherein managing configurations of the one or more remote monitoring devices comprises one or more of adding, removing or disconnecting one of the remote monitoring devices from the distributed system.

12. The distributed network monitoring system of claim 10, wherein managing configurations of the one or more remote monitoring devices comprises defining one or more properties of the remote monitoring devices, said properties including names and IP addresses.

13. The distributed network monitoring system of claim 10, wherein managing configurations of the one or more remote monitoring devices comprises specifying configurations for individual ones of the remote monitoring devices, said configurations including one or more of: definitions of logical groupings of nodes of a network being monitored, alert conditions for monitoring by the one or more remote monitoring devices, and types of data to be reported by the remote monitoring devices to the central monitoring device.

14. A method, comprising distributing configuration information for a plurality of network monitoring devices organized in a network from a first one of the network monitoring devices to one or more second ones of the network monitoring devices in response to requests for the configuration information received from the one or more second ones of the network monitoring devices.

15. The method of claim 14, wherein upon receipt of the configuration information, respective ones of the second ones of the network monitoring devices update existing configuration information stored thereat.

16. The method of claim 15, wherein updating existing configuration information includes resolving conflicts between the configuration information received from the first one of the network monitoring devices with local configuration information provided by a user.

17. The method of claim 16, wherein resolving conflicts comprises revising the local configuration information so as not to conflict with the configuration information received from the first one of the network monitoring devices.

18. A method, comprising establishing, on an as needed basis, one or more secure communications paths between secure communication tunnel processes executing at a central monitoring device and one or more remote monitoring devices of a distributed network monitoring system; and transmitting via said secure communication paths configuration information for the one or more remote monitoring devices.

19. The method of claim 18, wherein the configuration information is formatted according to version information of the one or more remote monitoring devices recognized at the central monitoring device from a request for the configuration information.

20. The method of claim 18, further comprising transmitting via said secure communication paths network monitoring data requested by a user through a management console communicatively coupled to the central monitoring device.
